(19) United States
(12) Patent Application Publication
(10) Pub. No.: US 2026/0359551 A1
(43) Pub. Date: Nov. 12, 2026

(54) ASYMMETRIC RELEVANCE VIA FRAGMENT-WISE EXECUTION OF NEURAL SENTENCE ENCODERS

(71) Applicant: International Business Machines Corporation, Armonk, NY (US)

(72) Inventors: Jeffrey Scott McCarley, Valhalla, NY (US); Radu Florian, Mount Kisco, NY (US); Robert Todd Ward, Croton on Hudson, NY (US)

(21) Appl. No.: 19/202,410

(22) Filed: May 8, 2025

(51) Int. Cl. G06F 40/126; G06F 16/2452; G06F 40/205; G06F 40/30

(52) U.S. Cl. CPC G06F 40/126; G06F 16/24522; G06F 40/205; G06F 40/30

(57) ABSTRACT

Systems or techniques that facilitate asymmetric relevance via fragment-wise execution of neural sentence encoders are provided. In various embodiments, a system can access a first textual passage and a neural sentence encoder. In various aspects, the system can generate a first embedding for the first textual passage based on independently executing the neural sentence encoder on a plurality of fragments of the first textual passage. In various instances, independent execution of the neural sentence encoder on the plurality of fragments can yield a plurality of fragment embeddings, and the first embedding for the first textual passage can be based on fusing the plurality of fragment embeddings. In various cases, the fusing can involve concatenating the plurality of fragment embeddings, or dimensionally-reduced versions thereof, together.

### BACKGROUND

The subject disclosure relates to natural language processing. When given a natural language query, a sentence that answers the natural language query can be identified via an embedding search through a sentence database. Unfortunately, existing techniques for performing such embedding search often identify imposter sentences, which can be undesirable.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can facilitate asymmetric relevance via fragment-wise execution of neural sentence encoders are described.

According to one or more embodiments, a system is provided. In various aspects, the system can comprise a processor that can execute computer-executable instructions stored in a non-transitory computer-readable memory. In various instances, such execution can cause the processor to facilitate various operations. In various cases, such operations can include accessing a first textual passage and a neural sentence encoder. In various aspects, such operations can include generating a first embedding for the first textual passage based on independently executing the neural sentence encoder on a plurality of fragments of the first textual passage. In various instances, independent execution of the neural sentence encoder on the plurality of fragments can yield a plurality of fragment embeddings, and the first embedding for the first textual passage can be based on fusing the plurality of fragment embeddings. In various cases, the fusing can involve concatenating the plurality of fragment embeddings, or dimensionally-reduced versions thereof, together.

In various aspects, the above-described system can be reformulated, reformatted, or otherwise implemented as a computer-implemented method or as a computer program product.

### DESCRIPTION OF THE DRAWINGS

FIG. 1 illustrates a block diagram of an example, non-limiting system that facilitates asymmetric relevance via fragment-wise execution of neural sentence encoders in accordance with one or more embodiments described herein.

FIG. 2 illustrates an example, non-limiting block diagram showing how a neural sentence encoder can be trained in accordance with one or more embodiments described herein.

FIG. 3 illustrates a block diagram of an example, non-limiting system including a sentence embedding and a query embedding that facilitates asymmetric relevance via fragment-wise execution of neural sentence encoders in accordance with one or more embodiments described herein.

FIGS. 4-7 illustrate example, non-limiting block diagrams showing how a sentence embedding and a query embedding can be asymmetrically generated in accordance with one or more embodiments described herein.

FIG. 8 illustrates example, non-limiting block diagrams showing how similarity can be computed between a sentence embedding and a query embedding in accordance with one or more embodiments described herein.

FIG. 9 illustrates example, non-limiting block diagrams showing how sub-sentence localizations of query answers can be facilitated in accordance with one or more embodiments described herein.

FIG. 10 illustrates a flow diagram of an example, non-limiting computer-implemented method that facilitates asymmetric relevance via fragment-wise execution of neural sentence encoders in accordance with one or more embodiments described herein.

FIG. 11 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

When given a natural language query (e.g., a plain text question or interrogative sentence), it can be desired to identify, within a sentence database (e.g., a document corpus), a sentence that semantically or substantively answers the natural language query. Such identification can be facilitated via an embedding search. In particular, a neural sentence encoder can be trained to produce embeddings (e.g., latent vector representations) for inputted sentences. Accordingly, that neural sentence encoder can be executed on each sentence in the sentence database, thereby yielding a respective embedding for each sentence in the sentence database. Additionally, the neural sentence encoder can be executed on the natural language query, thereby yielding an embedding for the natural language query. The embedding of the natural language query can then be compared (e.g., via cosine similarity or Euclidean distance) to that of each sentence in the sentence database, and whichever sentence in the sentence database has an embedding that is closest or most similar to that of the natural language query can be considered as semantically or substantively answering the natural language query.

Unfortunately, as the inventors of various embodiments described herein recognized, existing techniques for performing such embedding search often or frequently identify imposter sentences. In other words, existing techniques can be considered as exhibiting an unacceptably high likelihood to return as an answer to the natural language query a sentence that might initially seem relevant to the natural language query but that does not actually answer the natural language query. As an example, consider the natural language query, “Is Jane Doe a blacksmith?”. A sentence that correctly or accurately answers such query might be, “Renowned blacksmith Jane Doe honed her craft during a years-long apprenticeship in her youth.” On the other hand, an imposter sentence might be, “Over the weekend, Jane Smith, a noted veterinarian in the tri-county area, tirelessly worked to save a black-tailed doe and newborn fawn.” Because the natural language query has many words in common (e.g., “jane,” “doe,” “black,” “smith”) with both the correct sentence and the imposter sentence, whatever degree of similarity there is between the embedding of the natural language query and that of the correct sentence can be close to or nearly the same as the degree of similarity there is between the embedding of the natural language query and that of the imposter sentence. In some cases, the latter might be slightly higher than the former. In such situations, the imposter sentence is erroneously chosen as an answer to the natural language query. Such vulnerability to imposter sentences can be considered as undesirable or disadvantageous.

Accordingly, systems or techniques that can facilitate embedding searches that are less susceptible to imposter sentences can be desirable.

Various embodiments described herein can address one or more of these technical problems. Various embodiments described herein can include systems, computer-implemented methods, apparatus, or computer program products that can facilitate asymmetric relevance via fragment-wise execution of neural sentence encoders. Indeed, the present inventors realized why existing techniques are vulnerable to imposter sentences and devised various embodiments described herein to reduce or eliminate such vulnerability. Specifically, the present inventors realized that existing techniques are susceptible to imposter sentences because such existing techniques symmetrically execute neural sentence encoders on natural language queries and on sentences that might potentially answer those natural language queries. In other words, existing techniques search for symmetric relevance between sentences and queries.

More specifically, when given a query and a sentence that might answer the query, existing techniques generate a first embedding by feeding the query in its entirety to a neural sentence encoder, and existing techniques likewise generate a second embedding by feeding the sentence in its entirety to the neural sentence encoder. In other words, such existing techniques execute the neural sentence encoder on the sentence in the same that they execute the neural sentence encoder on the query, hence the terms “symmetric execution” and “symmetric relevance.” The present inventors realized that such symmetric execution of the neural sentence encoder can be considered as causing or forcing a subsequent embedding search to look for sentences that are most alike to the query. For example, if a similarity score between the first and second embeddings is above a threshold, the sentence can be considered as being semantically or substantively similar to, and thus answering, the query. In contrast, if the similarity score between the first and second embeddings is below the threshold, the sentence can be considered as being semantically or substantively dissimilar to, and thus not answering, the query. Because imposter sentences have many words in common to the query, their embeddings are likely to be similar to those of the query, which causes them to be incorrectly or erroneously identified as answers to the query.

However, the present inventors made the following observations: whatever main or key words that are within the query can be considered as having some fixed spatial relationship with respect to each other; whichever ones of those main or key words that are present in a correct sentence tend to have that same fixed spatial relationship with respect to each other; and whichever ones of those main or key words that are present in an imposter sentence tend to be physically spaced significantly farther apart from each other than that fixed spatial relationship. As an illustration, consider again the above example where the query is, “Is Jane Doe a blacksmith?”. In such example, “jane” and “doe” are physically close to each other (e.g., are adjacent words) in the query, “jane” and “doe” have that same physical closeness to each other in the correct sentence, but “jane” and “doe” are not physically close to each other (e.g., they have many intervening words in between them) in the imposter sentence. Likewise, in such example, “black” and “smith” are physically close to each other in the query, “black” and “smith” have that same physical closeness to each other in the correct sentence, but “black” and “smith” are not physically close to each other in the imposter sentence.

With these observations in mind, the present inventors realized that imposter sentences can be more reliably distinguished from correct sentences by asymmetrically executing the neural sentence encoder, such that whatever subsequent embedding search that is performed can be considered as searching for sentences that contain the query rather than searching for sentences that are alike to the query. In other words, various embodiments described herein can search for asymmetric relevance between sentences and queries. When given a query and a sentence that might answer the query, such asymmetric execution can be accomplished by: executing the neural sentence encoder on the query, thereby yielding an embedding for the query; executing the neural sentence encoder on individual or independent fragments of the sentence, rather than executing the neural sentence encoder on the sentence in its entirety, thereby yielding a respective embedding for each fragment; and creating an embedding for the sentence by fusing together the embeddings of the fragments. In such case, a similarity computation between the embedding of the query and that of the sentence can be considered as revealing whether something resembling the query is located somewhere within the sentence, as opposed to instead revealing whether the query resembles the sentence overall. Indeed, if the main or key words of the query are present in the sentence and are physically close or adjacent to each other within the sentence (e.g., if the sentence correctly answers the query), those main or key words can be highly likely to be located in the same fragment as each other, which will cause the embedding of at least one of the fragments to be highly similar to that of the query. In contrast, if the main or key words of the query are present in the sentence but are physically separated or far apart from each other within the sentence (e.g., if the sentence is an imposter), those main or key words are highly likely to be located in different or separate fragments than each other, which will cause the embedding of none of the fragments to be highly similar to that of the query. Thus, by executing the neural sentence encoder on the sentence differently than it is executed on the query (e.g., by physically breaking up the sentence into fragments and encoding each fragment independently, whereas the query is encoded in its entirety), whatever embedding search that is subsequently performed can be considered as being more robust or resilient to imposter sentences (e.g., can have a lower probability of erroneously returning an imposter sentence as an answer to a query).

Various embodiments described herein can be considered as a computerized tool (e.g., any suitable combination of computer-executable hardware or computer-executable software) that can facilitate asymmetric relevance via fragment-wise execution of neural sentence encoders. In various aspects, such a computerized tool can have an access component or an execution component.

In various embodiments, there can be a neural sentence encoder. In various aspects, the neural sentence encoder can exhibit any suitable deep learning internal architecture. For example, the neural sentence encoder can include any suitable numbers of any suitable types of layers (e.g., input layer, one or more hidden layers, output layer, any of which can be convolutional layers, dense layers, long short-term memory (LSTM) layers, transformer layers, non-linearity layers, pooling layers, batch normalization layers, or padding layers). As another example, the neural sentence encoder can include any suitable numbers of neurons in various layers (e.g., different layers can have the same or different numbers of neurons as each other). As yet another example, the neural sentence encoder can include any suitable activation functions (e.g., softmax, sigmoid, hyperbolic tangent, rectified linear unit) in various neurons (e.g., different neurons can have the same or different activation functions as each other). As still another example, the neural sentence encoder can include any suitable interneuron connections or interlayer connections (e.g., forward connections, skip connections, recurrent connections).

Regardless of its specific internal architecture, the neural sentence encoder can be configured to receive textual sentences as input and to produce embeddings for those textual sentences as output. In various aspects, an embedding produced by the neural sentence encoder in response to an inputted sentence can be considered as any suitable mathematical quantity (e.g., scalar, vector, matrix, tensor, tokenization, or any suitable combination thereof) that numerically represents at least some substantive or semantic aspect of that inputted sentence in a fixed-dimensional fashion. In other words, the embedding can have a fixed number of numerical elements, no matter how many words make up the inputted sentence. In still other words, the embedding can be considered as a latent vector representation of such inputted sentence. As some non-limiting examples, the embedding can be a 384-element vector, a 768-element vector, or a 1024-element vector.

In various embodiments, there can be a sentence and a natural language query. In various aspects, the sentence can be an unstructured or plain text declarative clause or statement that semantically or substantively describes something (e.g., some factoid). In various instances, the natural language query can be an unstructured or plain text interrogative clause or question that asks or otherwise seeks confirmation about something. In various cases, the sentence might or might not substantively or semantically answer the natural language query.

In various aspects, it can be desired to leverage the neural sentence encoder to determine whether or not the sentence answers the natural language query. As described herein, the computerized tool can accomplish such determination.

In various embodiments, the access component of the computerized tool can electronically access the sentence and the natural language query. For instance, the access component can receive, retrieve, or otherwise obtain the sentence and the natural language query from any suitable centralized or decentralized data structures (e.g., graph data structures, relational data structures, hybrid data structures). Likewise, the access component can electronically access the neural sentence encoder. For instance, the access component can electronically interface or communicate with (e.g., send electronic commands to, read electronic signals from) the neural sentence encoder. In any case, the access component can be considered as a conduit through which other components of the computerized tool can electronically interact with (e.g., read, write, edit, copy, manipulate, execute, activate, deactivate, modify) the sentence, the natural language query, or the neural sentence encoder.

In various embodiments, the execution component of the computerized tool can electronically leverage the neural sentence encoder to generate respective embeddings for the sentence and for the natural language query. In various aspects, the execution component can do so via asymmetric execution of the neural sentence encoder.

In particular, the execution component can execute the neural sentence encoder on the natural language query, and such execution can yield a query embedding. More specifically, the execution component can feed the natural language query to an input layer of the neural sentence encoder, the natural language query can complete a forward pass through one or more hidden layers of the neural sentence encoder, and an output layer of the neural sentence encoder can compute the query embedding based on activations produced by the one or more hidden layers. In any case, the query embedding can be a fixed-size numerical or latent vector representation of the natural language query.

Now, in various aspects, the execution component can refrain from executing the neural sentence encoder on the sentence. Instead, the execution component can break up or decompose the sentence into a plurality of sentence fragments. In various instances, the execution component can accomplish this via any suitable text parsing technique. In any case, the sentence can be considered as a sequence of words, and each of the plurality of sentence fragments can be considered as an unbroken subsequence of words from the sentence. That is, any given sentence fragment can contain fewer words than the sentence, whatever words that are included in that given sentence fragment can be ordered with respect to each other in the same way that those words are ordered within the sentence, and no two words of the sentence that are in that given sentence fragment can be separated by any word of the sentence that is not also within that given sentence fragment.

In various aspects, the execution component can independently or separately execute the neural sentence encoder on each of the plurality of sentence fragments, and such execution can yield a plurality of fragment embeddings. More specifically, for any particular sentence fragment, the execution component can feed the particular sentence fragment to the input layer of the neural sentence encoder, the particular sentence fragment can complete a forward pass through the one or more hidden layers of the neural sentence encoder, and the output layer of the neural sentence encoder can compute a respective fragment embedding based on activations produced by the one or more hidden layers, where such fragment embedding can be a fixed-size numerical or latent vector representation of the particular sentence fragment. By executing the neural sentence encoder in this way on each of the plurality of sentence fragments, the execution component can produce the plurality of fragment embeddings. Note that each of the plurality of fragment embeddings can have the same format, size, or dimensionality as the query embedding (e.g., after all, embeddings are fixed-dimensionality numerical representations of text).

In various instances, the execution component can fuse the plurality of fragment embeddings together, thereby yielding a sentence embedding which can be considered as a latent vector representation of the sentence. In some cases, such fusing can involve concatenating the plurality of fragment embeddings together to form the sentence embedding. In such situations, the dimensionality of (e.g., the number of numerical elements within) the sentence embedding can be an integer multiple of that of the query embedding. In other cases, such fusing can involve: projecting each of the plurality of fragment embeddings into a lower-dimensionality format or space, thereby yielding a plurality of compressed fragment embeddings; and concatenating the plurality of compressed fragment embeddings together to form the sentence embedding. In such situations, the lower-dimensionality format or space can be chosen based on how many fragments the sentence was broken into, such that the post-concatenation dimensionality of the sentence embedding is equal to that of the query embedding. Regardless of which of these fusing techniques is implemented, the sentence embedding can be considered as being generated asymmetrically or differently from how the query embedding is generated (e.g., the sentence embedding is generated by executing the neural sentence encoder on independent fragments of the sentence; the query embedding is not generated by executing the neural sentence encoder on independent fragments of the natural language query).

In various embodiments, the execution component can calculate a similarity score between the query embedding and the sentence embedding. In situations where the dimensionality of the sentence embedding is an integer multiple of that of the query embedding, the execution component can concatenate copies of the query embedding together so as to yield a concatenation whose dimensionality is equal to that of the sentence embedding, and the similarity score can be equal to or otherwise based on a cosine similarity or reciprocal of Euclidean distance between the sentence embedding and that concatenation of copies of the query embedding. On the other hand, in situations where the dimensionality of the sentence embedding is equal to that of the query embedding, the similarity score can be equal to a cosine similarity or reciprocal of Euclidean distance between the sentence embedding and the query embedding. In any case, the similarity score can be a scalar whose magnitude indicates a level of semantic or substantive similarity that there is between the natural language query and any individual fragments of the sentence (e.g., higher magnitudes of the similarity score can indicate more similarity; lower magnitudes of the similarity score can instead indicate less similarity). In various instances, if the similarity score is above any suitable threshold, the execution component can conclude that at least one of the fragments of the sentence resembles the natural language query, which means that the sentence can be expected to answer the natural language query. Instead, if the similarity score is below any suitable threshold, the execution component can conclude that none of the fragments of the sentence resembles the natural language query, which means that the sentence can be expected to not answer the natural language query.

In some embodiments, in response to the similarity score being above the threshold, the execution component can granularly localize which specific fragment of the sentence resembles the natural language query. In situations where the dimensionality of the sentence embedding is an integer multiple of that of the query embedding, such localization can be facilitated by computing a respective similarity score between the query embedding and each of the plurality of fragment embeddings (e.g., this allows identification of the specific fragment that is most alike to the natural language query). In situations where the dimensionality of the sentence embedding is equal to that of the query embedding, such localization can be facilitated by projecting the query embedding into the lower-dimensionality format or space and computing a respective similarity score between that compressed version of the query embedding and each of the plurality of compressed fragment embeddings (e.g., as above, this allows identification of the specific fragment that is most alike to the natural language query).

In any case, asymmetric execution of the neural sentence encoder (e.g., execution on the natural language query in its entirety, contrasted with execution on the individual fragments of the sentence) can reduce a likelihood of the sentence embedding being similar to the query embedding in situations where the sentence is an imposter (e.g., where the sentence shares many words with the natural language query but does not actually answer the natural language query).

Various embodiments described herein can be employed to use hardware or software to solve problems that are highly technical in nature (e.g., to facilitate asymmetric relevance via fragment-wise execution of neural sentence encoders), that are not abstract and that cannot be performed as a set of mental acts by a human. Further, some of the processes performed can be performed by a specialized computer (e.g., neural sentence encoders are specific types of deep learning neural networks).

For example, such defined tasks can include: accessing, by a device operatively coupled to a processor, a sentence and a neural sentence encoder; and generating, by the device, a first embedding for the sentence based on independently executing the neural sentence encoder on a plurality of sentence fragments of the sentence. In various aspects, independent execution of the neural sentence encoder on the plurality of sentence fragments can yield a plurality of fragment embeddings, and the first embedding for the sentence can be based on fusing the plurality of fragment embeddings. In various instances, such fusing can involve: concatenating by the device, the plurality of fragment embeddings together. In other instances, such fusing can involve: projecting, by the device, each of the plurality of fragment embeddings into a reduced-dimensionality format, thereby yielding a plurality of compressed fragment embeddings; and concatenating, by the device, the plurality of compressed fragment embeddings together. In various cases, such defined acts can include: accessing, by the device, a natural language query; generating, by the device, a second embedding for the natural language query based on executing the neural sentence encoder on the natural language query and not based on independently executing the neural sentence encoder on a plurality of fragments of the natural language query; computing, by the device, a similarity score between the first embedding and the second embedding; and determining, by the device, that the sentence semantically answers the natural language query, in response to the similarity score exceeding a threshold. In some aspects, such defined acts can involve: computing, by the device and in response to a determination that the sentence semantically answers the natural language query, a respective second similarity score between the second embedding and each of the plurality of fragment embeddings, thereby yielding a plurality of second similarity scores; and localizing, by the device, a most semantically-relevant one of the plurality of sentence fragments, based on identifying which of the plurality of second similarity scores exceeds the threshold.

Such defined acts are inherently computerized. Indeed, artificial neural networks (e.g., neural sentence encoders) are inherently computerized constructs comprising specific software-oriented architectures (e.g., input layers, hidden layers, or output layers, any of which can be made up of trainable or non-trainable internal parameters such as convolutional layers or LSTM layers). Artificial neural networks cannot be trained or executed by the human mind, or by humans with mere pen and paper, in any reasonable or practicable way without computers. Furthermore, the very field of natural language processing is about enabling computers to semantically understand and substantively respond to natural language queries, comments, commands, or instructions. It would make no sense whatsoever to discuss the field of natural language processing without computers.

Moreover, one or more embodiments described herein can integrate the herein-described teachings into a practical application. As mentioned above, when given a natural language query, it can be desired to identify a sentence that semantically answers that natural language query. Existing techniques facilitate this via a neural sentence encoder. Specifically, the natural language query is encoded into a query embedding by the neural sentence encoder, the sentence is encoded into a sentence embedding by the neural sentence encoder, and whether or not the sentence semantically answers the natural language query is determined based on a degree of similarity between the query embedding and the sentence embedding. Unfortunately, as the present inventors recognized, such existing techniques frequently identify imposter sentences as answers to natural language queries. Thus, existing techniques can be considered as suffering from a technical problem (e.g., from insufficiently high answering accuracy).

Fortunately, various embodiments described herein can address or otherwise ameliorate this technical problem. Indeed, the present inventors discovered why existing techniques are particularly susceptible to imposter sentences and devised various embodiments described herein to reduce or eliminate such susceptibility. Specifically, the present inventors recognized that existing techniques implement symmetric execution of the neural sentence encoder, meaning that such existing techniques execute the neural sentence encoder on the sentence in the same way that they execute the neural sentence encoder on the natural language query. More specifically, such existing techniques produce a query embedding by feeding the whole natural language query to the neural sentence encoder, and such existing techniques likewise produce a sentence embedding by feeding the whole sentence to the neural sentence encoder. The present inventors realized that such symmetric execution forces the subsequent similarity computation to effectively determine or measure how much the sentence as a whole resembles the natural language query. Because imposter sentences often share many words with the natural language query, the embeddings of such imposter sentences can, when produced via symmetric execution, be more likely to be similar to the embedding of the natural language query.

To address this problem, various embodiments described herein can instead implement asymmetric execution of the neural sentence encoder, meaning that such embodiments can execute the neural sentence encoder on the sentence in a different way than they execute the neural sentence encoder on the natural language query. More specifically, various embodiments can produce the query embedding by feeding the whole natural language query to the neural sentence encoder, but various embodiments can refrain from producing the sentence embedding by feeding the whole sentence to the neural sentence encoder. Instead, various embodiments can produce the sentence embedding by breaking the sentence up into multiple fragments and independently feeding each of those fragments to the neural sentence encoder. This can yield a respective embedding for each fragment of the sentence, and the sentence embedding can be obtained by fusing the embeddings of the fragments together. A degree of similarity can then be computed between the query embedding and the sentence embedding, where that degree of similarity can be considered as indicating how similar the natural language query is to any of the fragments of the sentence. Although imposter sentences often share many words with the natural language query, such shared words are often spaced much farther apart in those imposter sentences than they are in the natural language query. Thus, it is unlikely that those shared words within an imposter sentence would all be present within a single fragment of the imposter sentence, which concomitantly means that it is unlikely for the sentence embedding of the imposter sentence to be similar to the query embedding when produced via asymmetric execution. In contrast, correct sentences often share many words with the natural language query, and such shared words are often spaced as close together in those correct sentences as they are in the natural language query. Thus, it is likely that those shared words within a correct sentence would all be present within a single fragments of the correct sentence, which concomitantly means that it is likely for the sentence embedding of the correct sentence to be similar to the query embedding when produced via asymmetric execution.

In other words, asymmetric execution of the neural sentence encoder, which can force a subsequent embedding search to look for sentences that contain something resembling the natural language query, can be considered as less often erroneously identifying imposter sentences. In contrast, the symmetric execution of the neural sentence encoder taught by existing techniques, which can force a subsequent embedding search to look for sentences that resemble in their entireties the natural language query, can be considered as more often erroneously identifying imposter sentences.

For at least these reasons, various embodiments described herein provide concrete and tangible technical improvements or technical effects in the field of natural language processing. Therefore, such embodiments certainly constitute useful and practical applications of computers.

It should be appreciated that the figures and the herein disclosure describe non-limiting examples of various embodiments. It should further be appreciated that the figures are not necessarily drawn to scale.

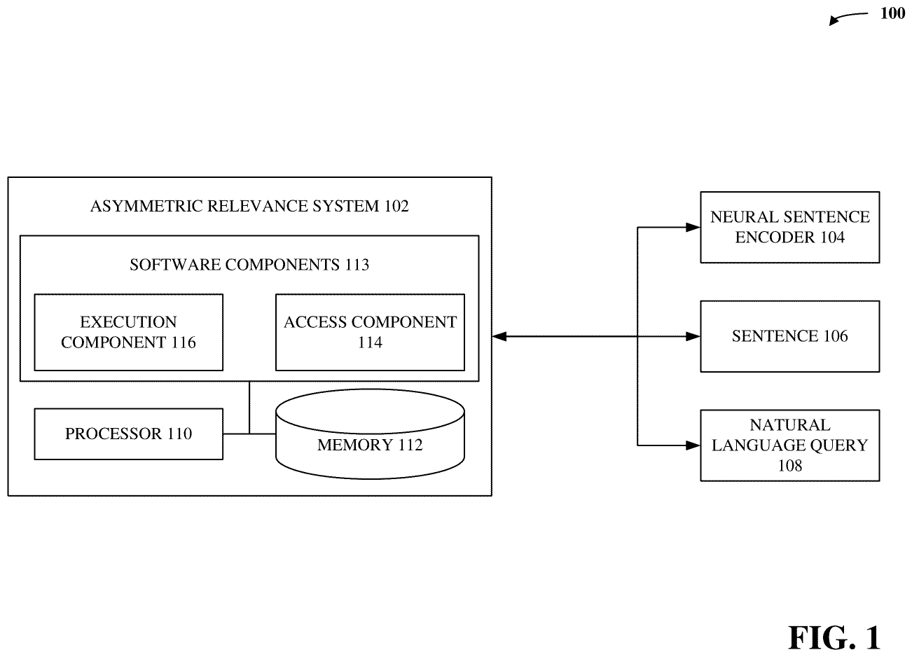

FIG. 1 illustrates a block diagram of an example, non-limiting system 100 that can facilitate asymmetric relevance via fragment-wise execution of neural sentence encoders in accordance with one or more embodiments described herein.

In various embodiments, there can be a neural sentence encoder 104. In various aspects, the neural sentence encoder 104 can exhibit any suitable deep learning internal architecture. Indeed, in various cases, the neural sentence encoder 104 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

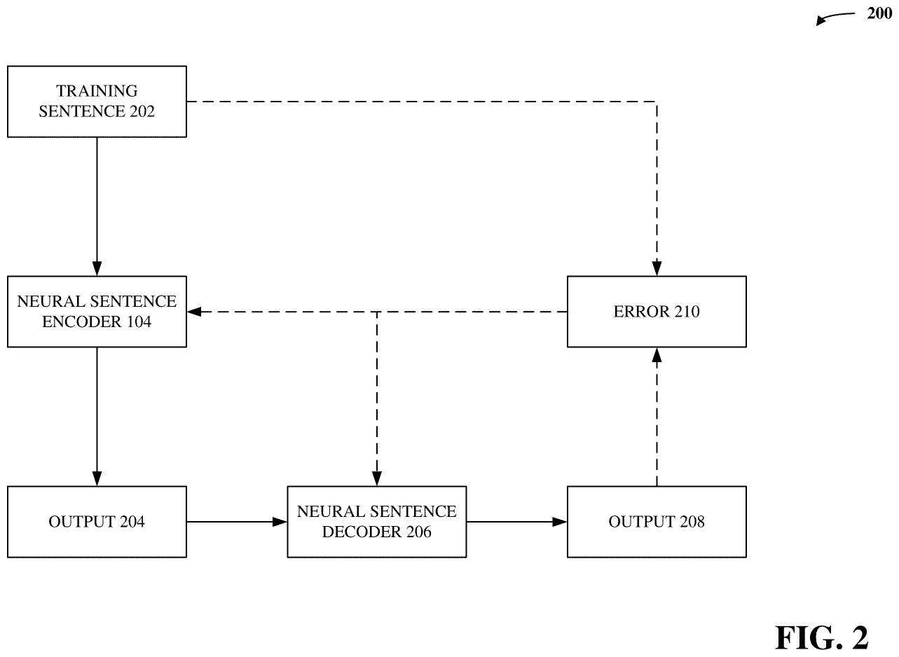

Regardless of the specific internal architecture (e.g., the specific numbers, types, or organizations of layers) that is implemented within the neural sentence encoder 104, the neural sentence encoder 104 can be configured to receive textual sentences as input and to produce as output fixed-dimensionality embeddings that numerically represent such inputted textual sentences. In order to ensure that such fixed-dimensionality embeddings are correct or accurate (e.g., to ensure that such fixed-dimensionality embeddings actually reflect the semantic or substantive content of those inputted textual sentences), the neural sentence encoder 104 can undergo any suitable type of training. Various non-limiting aspects of such training are described with respect to FIG. 2.

FIG. 2 illustrates an example, non-limiting block diagram 200 showing how the neural sentence encoder 104 can be trained in accordance with one or more embodiments described herein. In particular, the neural sentence encoder 104 can be trained (e.g., by the asymmetric relevance system 102 or by any other suitable computing device) in unsupervised fashion by leveraging a neural sentence decoder 206.

In various aspects, the neural sentence decoder 206 can exhibit any suitable deep learning internal architecture. Indeed, in various cases, the neural sentence decoder 206 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

Regardless of the specific internal architecture that is implemented within the neural sentence decoder 206, the neural sentence decoder 206 can be configured to receive fixed-dimensionality embeddings as input and to produce as output textual sentences that are numerically represented by such inputted fixed-dimensionality embeddings. In other words, the neural sentence decoder 206 can be considered as performing the functional inverse of the neural sentence encoder 104.

In various aspects, the neural sentence encoder 104 and the neural sentence decoder 206 can be trained simultaneously as or otherwise in conjunction with each other. Prior to beginning training, the trainable internal parameters (e.g., convolutional kernels, weight matrices, bias values) of the neural sentence encoder 104 and of the neural sentence decoder 206 can be initialized in any suitable fashion (e.g., via random initialization).

In various embodiments, there can be a training sentence 202. In various aspects, the training sentence 202 can be any suitable grammatically coherent plain text or natural language sequence of words. In various instances, the training sentence 202 can contain or be made up of any suitable number words. In various cases, the training sentence 202 can be of any suitable semantic type. As some non-limiting examples, the training sentence 202 can be interrogative (e.g., a question), declarative (e.g., a statement), imperative (e.g., a command), or exclamatory (e.g., a conveyance of strong emotion).

In any case, the neural sentence encoder 104 can be executed on the training sentence 202, thereby causing the neural sentence encoder 104 to produce an output 204. More specifically, the training sentence 202 can be fed or routed to the input layer of the neural sentence encoder 104, the training sentence 202 can complete a forward pass through the one or more hidden layers of the neural sentence encoder 104, and the output layer of the neural sentence encoder 104 can compute the output 204 based on activation maps or feature maps provided by the one or more hidden layers of the neural sentence encoder 104 during such forward pass.

Note that the format, size, or dimensionality of the output 204 can be dictated by the number, arrangement, sizes, or other characteristics of the neurons, convolutional kernels, attention blocks, or other internal parameters of the output layer (or of any other layers) of the neural sentence encoder 104. Accordingly, the output 204 can be forced to have any desired format, size, or dimensionality, by adding, removing, or otherwise adjusting characteristics of the output layer (or of any other layers) of the neural sentence encoder 104. In particular, the output 204 can be forced to have a fixed format, size, or dimensionality (e.g., can be forced to be a fixed-length vector). Thus, the output 204 can be considered as being a predicted or inferred embedding that latently captures or otherwise numerically represents (in the opinion of the neural sentence encoder 104) the substantive or semantic content of the training sentence 202. Note that, if the neural sentence encoder 104 has so far undergone no or little training, then the output 204 can be highly inaccurate. In other words, the output 204 can fail to truly or accurately latently capture or otherwise numerically represent the substantive or semantic content of the training sentence 202.

In various aspects, the neural sentence decoder 206 can be executed on the output 204, thereby causing the neural sentence decoder 206 to produce an output 208. More specifically, the output 204 can be fed or routed to the input layer of the neural sentence decoder 206, the output 204 can complete a forward pass through the one or more hidden layers of the neural sentence decoder 206, and the output layer of the neural sentence decoder 206 can compute the output 208 based on activation maps or feature maps provided by the one or more hidden layers of the neural sentence decoder 206 during such forward pass.

Just as above, note that the format, size, or dimensionality of the output 208 can be dictated by the number, arrangement, sizes, or other characteristics of the neurons, convolutional kernels, attention blocks, or other internal parameters of the output layer (or of any other layers) of the neural sentence decoder 206. Accordingly, the output 208 can be forced to have any desired format, size, or dimensionality, by adding, removing, or otherwise adjusting characteristics of the output layer (or of any other layers) of the neural sentence decoder 206. In particular, the output 208 can be forced to be a variable-length sequence of words. Accordingly, the output 208 can be considered as being a predicted or inferred plain text or natural language sentence that conveys (in the opinion of the neural sentence decoder 206) whatever substantive or semantic content is latently captured or otherwise numerically represented by the output 204. Just as above, note that, if the neural sentence decoder 206 has so far undergone no or little training, then the output 208 can be highly inaccurate. In other words, the output 208 can fail to truly or accurately convey via plain text or natural language whatever semantic or substantive content that is latently captured or otherwise numerically represented by the output 204.

Furthermore, note how the neural sentence encoder 104 and the neural sentence decoder 206 can be considered as collectively forming a bottleneck structure: the neural sentence encoder 104 attempts to convert the training sentence 202 into a predicted embedding; and the neural sentence decoder 206 attempts to reconstruct the training sentence 202 from that predicted embedding.

In any case, an error 210 (e.g., mean absolute error, mean squared error, cross-entropy error) between the output 208 and the training sentence 202 can be computed. In various instances, the trainable internal parameters of both the neural sentence encoder 104 and the neural sentence decoder 206 can be incrementally updated via backpropagation (e.g., stochastic gradient descent) based on the error 210.

In various cases, such execution-and-update procedure can be repeated for any suitable number of training sentences. This can ultimately cause: the trainable internal parameters of the neural sentence decoder 206 to become iteratively optimized for accurately reconstructing sentences from inputted embeddings; and the trainable internal parameters of the neural sentence encoder 104 to become iteratively optimized for accurately generating embeddings from inputted sentences. In various aspects, any suitable training batch sizes, any suitable error/loss functions, or any suitable training termination criteria can be utilized during such training.

Although the herein disclosure mainly describes the neural sentence encoder 104 as being trained in unsupervised fashion using a bottleneck pipeline, this is a mere non-limiting example for ease of explanation and illustration. In various embodiments, any other suitable training paradigms can be used to train the neural sentence encoder 104, such as supervised training, semi-supervised training, or reinforcement learning, any of which may be federated or unfederated. Indeed, in some cases, the neural sentence encoder 104 can be trained on pairs of sentences using a contrastive error, loss, or objective function. Such pair-based training can be implemented in lieu of, or in addition to, any training techniques mentioned above.

Referring back to FIG. 1, there can be a sentence 106. In various aspects, the sentence 106 can be any suitable grammatically coherent plain text or natural language sequence of words. In various instances, the sentence 106 can contain or be made up of any suitable number words. In various cases, the sentence 106 can be of a declarative semantic type. As a non-limiting example, the sentence 106 can describe or state a factoid (e.g., any suitable piece of factual trivia concerning any suitable subject matter or topic).

In various aspects, there can be a natural language query 108. In various instances, the natural language query 108 can be any suitable grammatically coherent plain text or natural language sequence of words. In various cases, the natural language query 108 can contain or be made up of any suitable number words. In some situations, the natural language query 108 can be of an interrogative semantic type. As a non-limiting example, the natural language query 108 can be a question. In other situations, the natural language query 108 can be of a declarative semantic type. As a non-limiting example, the natural language query 108 can describe or state a factoid.

In any case, it can be desired to determine whether or not the sentence 106 is substantively or semantically relevant to the natural language query 108. As a non-limiting example, if the natural language query 108 is a question, it can be desired to determine whether or not the sentence 106 answers that question. As another non-limiting example, if the natural language query 108 is a statement of some factoid, it can be desired to determine whether or not the sentence 106: either confirms (e.g., is consistent with) or invalidates (e.g., is inconsistent with) the natural language query 108; or neither confirms nor invalidates the natural language query 108. In any of such situations, an asymmetric relevance system 102 can facilitate such determination as described herein.

In various embodiments, the asymmetric relevance system 102 can include a processor 110 (e.g., computer processing unit, microprocessor) and a non-transitory computer-readable memory 112 that is operably connected or coupled to the processor 110. The memory 112 can store computer-executable instructions which, upon execution by the processor 110, can cause the processor 110 or other components of the asymmetric relevance system 102 (e.g., access component 114, execution component 116) to perform one or more acts. In various embodiments, the memory 112 can store computer-executable components (e.g., access component 114, execution component 116), and the processor 110 can execute the computer-executable components.

In various embodiments, the asymmetric relevance system 102 can include an access component 114. In various aspects, the access component 114 can electronically access, in any suitable fashion, the neural sentence encoder 104. That is, the access component 114 can establish any suitable type of electronic communication with the neural sentence encoder 104, such that the asymmetric relevance system 102 can electronically execute, electronically modify, or otherwise electronically control the neural sentence encoder 104. Furthermore, in various instances, the access component 114 can electronically receive, retrieve, obtain, import, or otherwise access, from any suitable data structures or from any suitable computing devices, the sentence 106 or the natural language query 108. Accordingly, the access component 114 can be considered as proxy or conduit through which any other component of the asymmetric relevance system 102 can electronically interact with or otherwise manipulate the neural sentence encoder 104, the sentence 106, or the natural language query 108.

In various embodiments, the asymmetric relevance system 102 can include an execution component 116. In various aspects, the execution component 116 can, as described herein, leverage the neural sentence encoder 104 to asymmetrically generate embeddings for the sentence 106 and the natural language query 108. In various instances, the execution component 116 can, as described herein, utilize those asymmetrically-generated embeddings to determine whether or not the sentence 106 is semantically or substantively relevant to the natural language query 108.

Note that, in various instances, the access component 114 and the execution component 116 can collectively be considered as being one or more software components 113 of the asymmetric relevance system 102. In various aspects, it should be appreciated that the one or more software components 113 are described primarily herein as comprising two components (e.g., the access component 114 and the execution component 116) for ease of explanation and illustration. However, the one or more software components 113 are not limited to being implemented as exactly such two components in every embodiment. Indeed, in some embodiments, the functionalities described herein of such two components can be combined in any suitable fashions, so as to be implemented in or by fewer than two components (e.g., in some cases, a single component can perform all of the functionalities that are described herein with respect to the access component 114 and the execution component 116). In other embodiments, the functionalities described herein of such two components can instead be distributed, separated, split, or fragmented in any suitable fashions, so as to be implemented in or by more than two components (e.g., two or more components can facilitate the functionalities that are performable by the access component 114; two or more components can facilitate the functionalities that are performable by the execution component 116).

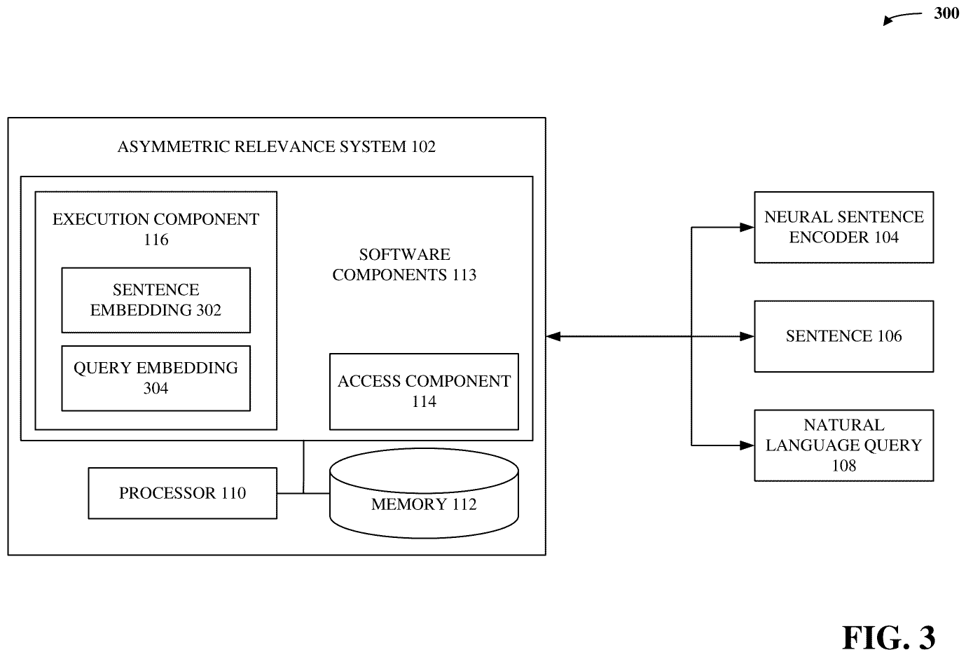

FIG. 3 illustrates a block diagram of an example, non-limiting system 300 including a sentence embedding and a query embedding that can facilitate asymmetric relevance via fragment-wise execution of neural sentence encoders in accordance with one or more embodiments described herein. As shown, the system 300 can, in some cases, include the same components as the system 100, and can further include a sentence embedding 302 and a query embedding 304.

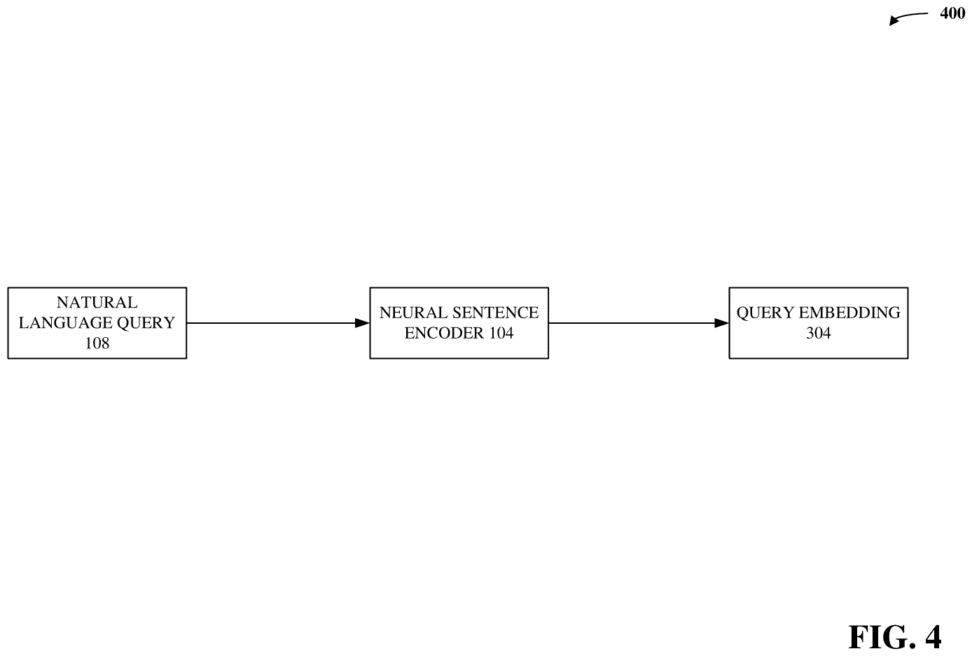

In various embodiments, the execution component 116 can asymmetrically execute the neural sentence encoder 104 with respect to the sentence 106 and the natural language query 108, so as to produce the sentence embedding 302 and the query embedding 304. Various non-limiting aspects are described with respect to FIGS. 4-7.

FIGS. 4-7 illustrate example, non-limiting block diagrams showing how the sentence embedding 302 and the query embedding 304 can be asymmetrically generated in accordance with one or more embodiments described herein.

First, consider FIG. 4, which shows a block diagram 400. In various embodiments, the execution component 116 can electronically execute the neural sentence encoder 104 on the natural language query 108. In various aspects, such execution can yield the query embedding 304. More specifically, the execution component 116 can feed or route the natural language query 108 to the input layer of the neural sentence encoder 104. In various instances, the natural language query 108 can thus complete a forward pass through the one or more hidden layers of the neural sentence encoder 104. In various cases, the output layer of the neural sentence encoder 104 can accordingly compute or calculate the query embedding 304, based on whatever hidden activation maps or hidden feature maps are produced by the one or more hidden layers during that forward pass. In various aspects, the query embedding 304 can be a latent vector representation of whatever semantic or substantive content is conveyed by the natural language query 108. As a non-limiting example, the query embedding 304 can be a d-element vector, for any suitable positive integer d>1.

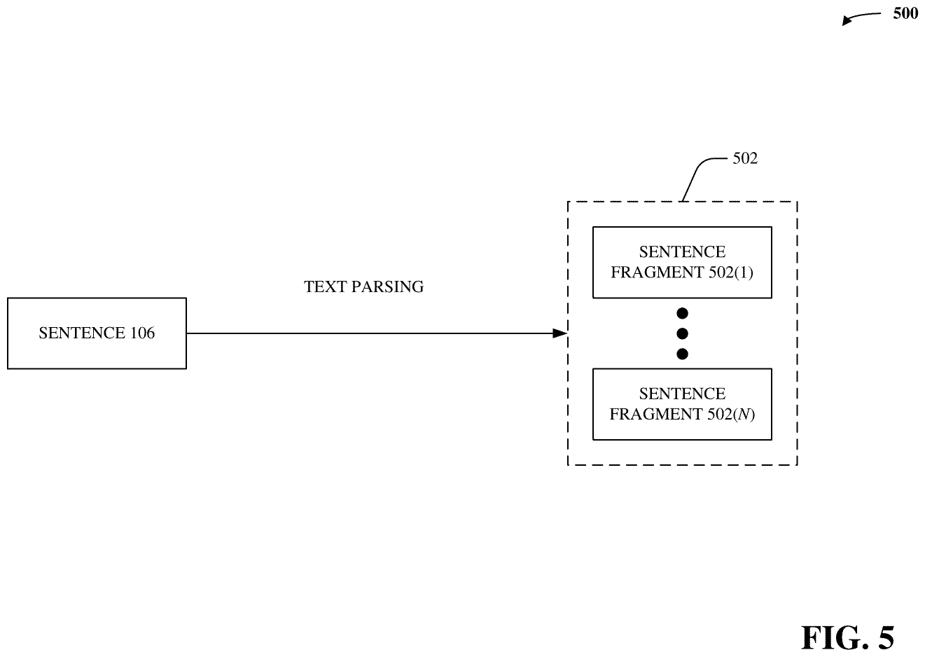

Next, consider FIG. 5, which shows a block diagram 500. In various embodiments, the execution component 116 can refrain from executing the neural sentence encoder 104 on the sentence 106. Instead, the execution component 116 can electronically decompose, electronically divide, or electronically break up the sentence 106 into a plurality of sentence fragments 502. In various aspects, the execution component 116 can accomplish such decomposition, division, or breakage via any suitable text parsing technique. Some non-limiting examples of text parsing techniques can include: named entity recognition parsing; tokenization parsing; syntactic parsing; dependency parsing; or constituency parsing.

In various instances, the plurality of sentence fragments 502 can include n fragments for any suitable positive integer n>1: a sentence fragment 502(1) to a sentence fragment 502(n). In various cases, the sentence 106 can be considered as a sequence of words, and each of the plurality of sentence fragments 502 can be a respective contiguous, unbroken, or unchanged subsequence of words from the sentence 106. That is, for any given one of the plurality of sentence fragments 502, that given sentence fragment can contain one or more words that are present within the sentence 106, where such one or more words are ordered with respect to each other within that given sentence fragment in the same way that they are ordered with respect to each other within the sentence 106, and where such one or more words are not separated from each other within the sentence 106 by any word that is not a member of that given sentence fragment. In any case, a union of the plurality of sentence fragments 502 can be equal to the sentence 106. That is, each word of the sentence 106 can be assigned or otherwise belong to at least one of the plurality of sentence fragments 502. In some instances, the plurality of sentence fragments 502 can be disjoint or non-overlapping with each other. That is, each word of the sentence 106 can be assigned or otherwise belong to exactly one of the plurality of sentence fragments 502. In other instances, however, the plurality of sentence fragments 502 can be non-disjoint or overlapping with each other. That is, each word of the sentence 106 can be assigned or otherwise belong to one or more of the plurality of sentence fragments 502 (e.g., some words might belong to multiple fragments). Note that different ones of the plurality of sentence fragments 502 can be made up of the same or different numbers of words as each other. Additionally, note that different ones of the plurality of sentence fragments 502 can be considered as representing or otherwise being confined to different physical locations or positions within the sentence 106. That is, each of the plurality of sentence fragments 502 can be considered as a respective group of adjacent words in the sentence 106.

As a non-limiting example, suppose that the sentence 106 is, “Over the weekend, Jane Smith, a noted veterinarian in the tri-county area, tirelessly worked to save a black-tailed doe and newborn fawn.” In such case, “over the weekend” can be considered as a first fragment of the sentence 106, “jane smith, a noted veterinarian in the tri-county area” can be considered as a second fragment of the sentence 106, “tirelessly worked to save” can be considered as a third fragment of the sentence 106, and “a black-tailed doe and newborn fawn” can be considered as a fourth fragment of the sentence 106.

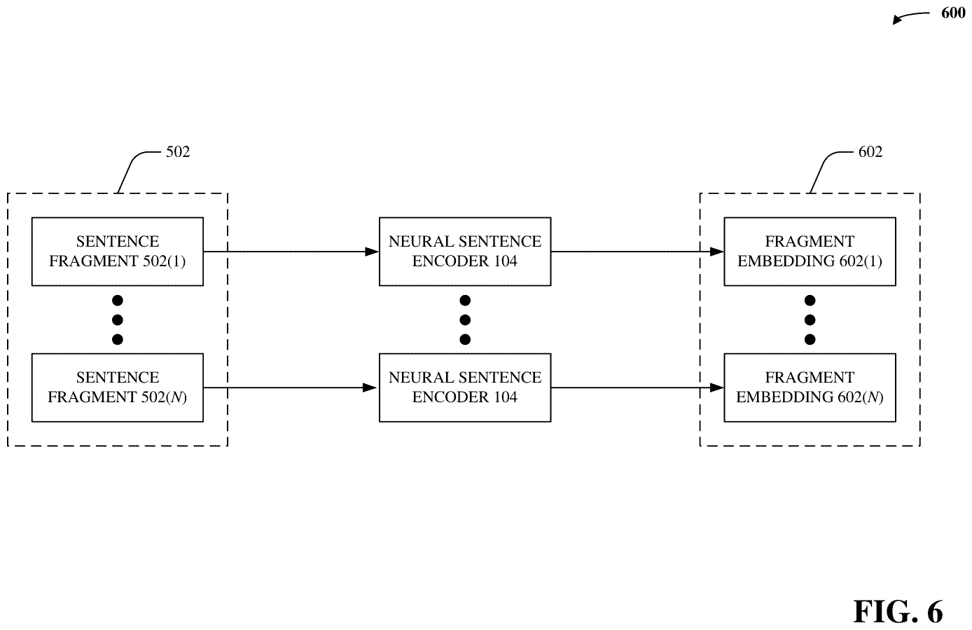

Now, consider FIG. 6, which shows a block diagram 600. In various embodiments, the execution component 116 can electronically execute the neural sentence encoder 104 on each of the plurality of sentence fragments 502, and such executions can collectively yield a plurality of fragment embeddings 602.

As a non-limiting example, the execution component 116 can electronically execute the neural sentence encoder 104 on the sentence fragment 502(1). In various aspects, such execution can yield a fragment embedding 602(1). More specifically, the execution component 116 can feed or route the sentence fragment 502(1) to the input layer of the neural sentence encoder 104. In various instances, the sentence fragment 502(1) can thus complete a forward pass through the one or more hidden layers of the neural sentence encoder 104. In various cases, the output layer of the neural sentence encoder 104 can accordingly compute or calculate the fragment embedding 602(1), based on whatever hidden activation maps or hidden feature maps are produced by the one or more hidden layers during that forward pass. In various aspects, the fragment embedding 602(1) can be a latent vector representation of whatever semantic or substantive content is conveyed by the sentence fragment 502(1). Note that the fragment embedding 602(1) can be unaffected or uninfluenced by the whatever words of the sentence 106 are not in the sentence fragment 502(1). Additionally, note that the fragment embedding 602(1) can have the same format, size, or dimensionality as the query embedding 304. So, the fragment embedding 602(1) can, just like the query embedding 304, be a d-element vector.

As another non-limiting example, the execution component 116 can electronically execute the neural sentence encoder 104 on the sentence fragment 502(n). In various aspects, such execution can yield a fragment embedding 602(n). More specifically, the execution component 116 can feed or route the sentence fragment 502(n) to the input layer of the neural sentence encoder 104. In various instances, the sentence fragment 502(n) can thus complete a forward pass through the one or more hidden layers of the neural sentence encoder 104. In various cases, the output layer of the neural sentence encoder 104 can accordingly compute or calculate the fragment embedding 602(n), based on whatever hidden activation maps or hidden feature maps are produced by the one or more hidden layers during that forward pass. In various aspects, the fragment embedding 602(n) can be a latent vector representation of whatever semantic or substantive content is conveyed by the sentence fragment 502(n). Note that the fragment embedding 602(n) can be unaffected or uninfluenced by the whatever words of the sentence 106 are not in the sentence fragment 502(n). Additionally, note that the fragment embedding 602(n) can have the same format, size, or dimensionality as the query embedding 304. So, the fragment embedding 602(n) can, just like the query embedding 304, be a d-element vector.

In various cases, the fragment embedding 602(1) to the fragment embedding 602(n) can collectively be considered as forming the plurality of fragment embeddings 602.

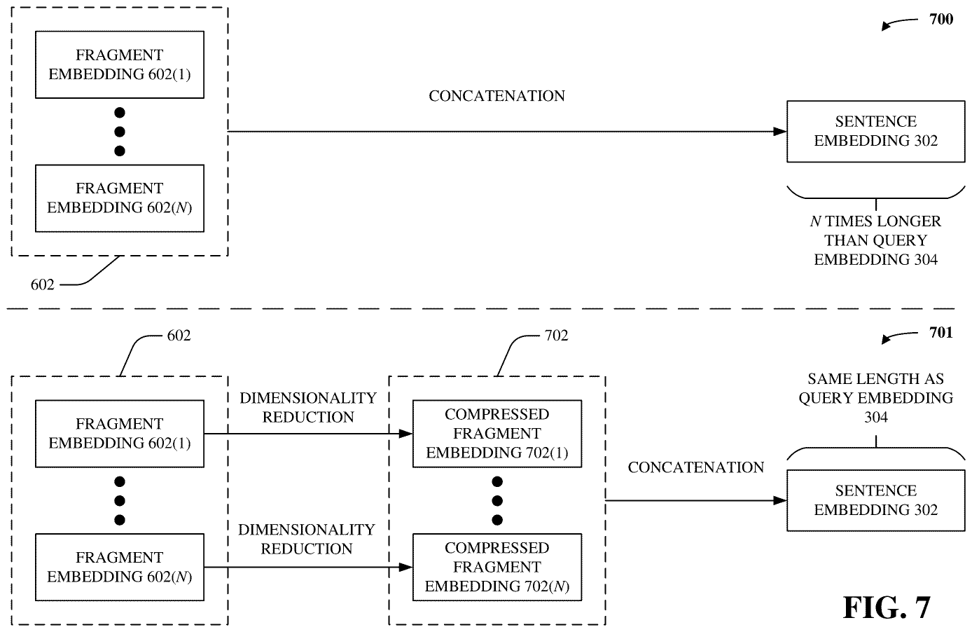

Next, consider FIG. 7, which shows a block diagram 700 and a block diagram 701. In various embodiments, the execution component 116 can electronically generate the sentence embedding 302 by fusing the plurality of fragment embeddings 602.

In some situations, as shown with respect to the block diagram 700, such fusing can involve concatenating the plurality of fragment embeddings 602 together. In such case, the sentence embedding 302 can be n times longer than the query embedding 304. That is, the sentence embedding 302 can be an nd-element vector.

However, in other situations, as shown with respect to the block diagram 701, such fusing can instead involve projecting each of the plurality of fragment embeddings 602 into a lower-dimensionality space. More specifically, the execution component 116 can, in various aspects, apply any suitable dimensionality reduction technique to each of the plurality of fragment embeddings 602, thereby yielding a plurality of compressed fragment embeddings 702. As some non-limiting examples, such dimensionality reduction technique can be: principal component analysis (PCA); singular value decomposition (SVD); linear discriminant analysis (LDA); t-distributed stochastic neighbor embedding (t-SNE); or uniform manifold approximation and projection (UMAP).

In any case, each of the plurality of compressed fragment embeddings 702 can be a dimensionally-smaller or shorter version of a respective one of the plurality of fragment embeddings 602. As a non-limiting example, a compressed fragment embedding 702(1) can be formed by applying any suitable dimensionality reduction technique to the fragment embedding 602(1). So, the compressed fragment embedding 702(1) can indicate, convey, or otherwise numerically represent the same substantive or semantic content as the fragment embedding 602(1), but the compressed fragment embedding 702(1) can do so via c numerical elements, for any suitable positive integer c<d (e.g., can be a c-element vector rather than a d-element vector). As another non-limiting example, a compressed fragment embedding 702(n) can be formed by applying any suitable dimensionality reduction technique to the fragment embedding 602(n). Thus, the compressed fragment embedding 702(n) can indicate, convey, or otherwise numerically represent the same substantive or semantic content as the fragment embedding 602(n), but the compressed fragment embedding 702(n) can do so via c numerical elements.

Note that the compressed fragment embedding 702(1) to the compressed fragment embedding 702(n) can collectively be considered as the plurality of compressed fragment embeddings 702.

In some cases, c=d/n. In such situations, the execution component 116 can concatenate the plurality of compressed fragment embeddings 702 together so as to form the sentence embedding 302. Note that the sentence embedding 302 in such situations can thus have the same format, size, or dimensionality as the query embedding 304. In other words, when the sentence embedding 302 is formed by concatenating the plurality of compressed fragment embeddings 702, the sentence embedding 302 can be a d-element vector.

Note how the sentence embedding 302 can be considered as being generated asymmetrically as compared to the query embedding 304. Indeed, the query embedding 304 can be obtained by executing the neural sentence encoder 104 on the entirety of the natural language query 108 (e.g., the natural language query 108 is not broken up or decomposed into fragments on which the neural sentence encoder 104 is independently executed). In contrast, the sentence embedding 302 can instead be obtained by breaking the sentence 106 up into the plurality of sentence fragments 502 and independently or separately executing the neural sentence encoder 104 on each of the plurality of sentence fragments 502. Thus, the query embedding 304 can be considered as representing the semantic or substantive content of the natural language query 108, whereas the sentence embedding 302 can instead be considered as more granularly representing the semantic or substantive contents of the individual ones of the plurality of sentence fragments 502. In other words, the sentence embedding 302 can be unaffected by semantic or lexical interrelationships that there might be between words of the sentence 106 that are spaced far apart from each other (e.g., between words of the sentence 106 that are not in the same fragment as each other). If the neural sentence encoder 104 were instead executed on the sentence 106 in its entirety (e.g., without first fragmenting the sentence 106), then the sentence embedding 302 would instead be heavily affected by semantic or lexical interrelationships that there might be between words of the sentence 106 that are spaced far apart from each other.

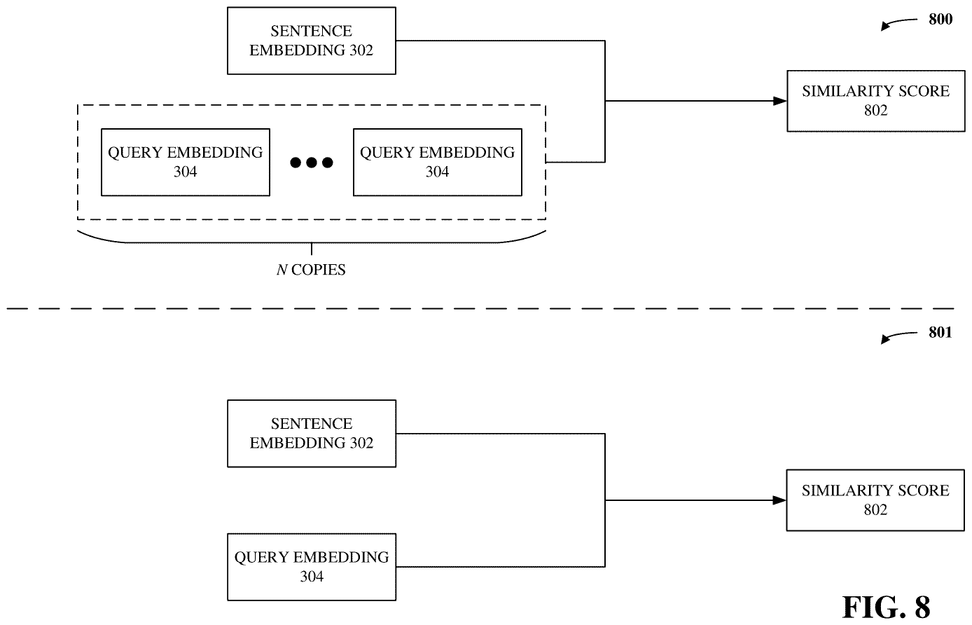

FIG. 8 illustrates example, non-limiting block diagrams 800 and 801 showing how similarity can be computed between the sentence embedding 302 and the query embedding 304 in accordance with one or more embodiments described herein.

In various embodiments, the execution component 116 can electronically compute a similarity score 802 based on the sentence embedding 302 and the query embedding 304.

In situations where the sentence embedding 302 is already of the same format, size, or dimensionality as the query embedding 304, the similarity score 802 can, as shown by the block diagram 801, be equal to or otherwise based on a cosine similarity (or reciprocal or complement of Euclidean distance) between the sentence embedding 302 and the query embedding 304. Note that the block diagram 801 can be considered as corresponding to or continuing from the block diagram 701.

However, in situations where the sentence embedding 302 is n times longer than the query embedding 304, the execution component 116 can, as shown in the block diagram 800, generate n copies of the query embedding 304 and can concatenate those n copies together. In such case, the similarity score 802 can be equal to or otherwise based on a cosine similarity (or reciprocal or complement of Euclidean distance) between the sentence embedding 302 and that n-order concatenation of the query embedding 304. Note that the block diagram 800 can be considered as corresponding to or continuing from the block diagram 700.

In any case, the similarity score 802 can be a scalar whose magnitude can be considered not as representing how semantically similar the natural language query 108 is to the sentence 106, but instead as representing how semantically similar the natural language query 108 is to at least one fragment within the sentence 106. In response to the similarity score 802 satisfying any suitable threshold value, the execution component 116 can conclude that the sentence 106 contains something that resembles the natural language query 108, and thus can conclude that the sentence 106 is relevant to (e.g., answers; either confirms or invalidates) the natural language query 108. On the other hand, in response to the similarity score 802 failing to satisfy any suitable threshold value, the execution component 116 can conclude that the sentence 106 does not contain anything that resembles the natural language query 108, and thus can conclude that the sentence 106 is irrelevant to (e.g., does not answer; neither confirms nor invalidates) the natural language query 108.

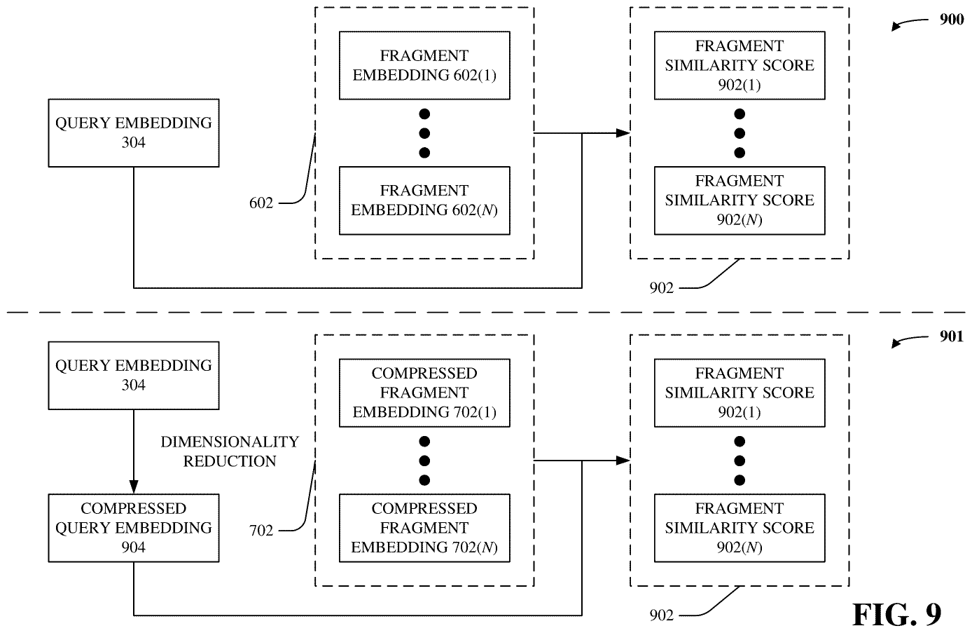

FIG. 9 illustrates example, non-limiting block diagrams 900 and 901 showing how sub-sentence localizations of query answers can be facilitated in accordance with one or more embodiments described herein.

In various embodiments, in response to determining that the sentence 106 is relevant to the natural language query 108, the execution component 116 can electronically localize which specific part of the sentence 106 is most relevant to the natural language query 108. That is, the execution component 116 can identify which one of the plurality of sentence fragments 502 most resembles the natural language query 108.

As shown in the block diagram 900, in situations where dimensionality reduction is not applied to the plurality of fragment embeddings 602, the execution component 116 can generate a plurality of fragment similarity scores 902, based on comparing the query embedding 304 to each of the plurality of fragment embeddings 602. As a non-limiting example, a fragment similarity score 902(1) can be equal to or otherwise based on a cosine similarity (or reciprocal or complement of Euclidean distance) between the query embedding 304 and the fragment embedding 602(1). As another non-limiting example, a fragment similarity score 902(n) can be equal to or otherwise based on a cosine similarity (or reciprocal or complement of Euclidean distance) between the query embedding 304 and the fragment embedding 602(n). Note that the fragment similarity score 902(1) to the fragment similarity score 902(n) can collectively be considered as forming the plurality of fragment similarity scores 902.

As shown in the block diagram 901, in situations where dimensionality reduction is applied to the plurality of fragment embeddings 602, the execution component 116 can generate the plurality of fragment similarity scores 902 just as described above, or the execution component 116 can instead generate the plurality of fragment similarity scores 902 based on comparing a compressed query embedding 904 to each of the plurality of compressed fragment embeddings 702. In various aspects, the compressed query embedding 904 can be obtained by applying any suitable dimensionality reduction technique to the query embedding 304, such that the compressed query embedding 904 conveys or represents the same substantive or semantic content as the query embedding 304 but does so with a dimensionality of c rather than a dimensionality of d. In such case, the fragment similarity score 902(1) can be equal to or otherwise based on a cosine similarity (or reciprocal or complement of Euclidean distance) between the compressed query embedding 904 and the compressed fragment embedding 702(1). Likewise, the fragment similarity score 902(n) can be equal to or otherwise based on a cosine similarity (or reciprocal or complement of Euclidean distance) between the compressed query embedding 904 and the compressed fragment embedding 702(n).

In any case, each of the plurality of fragment similarity scores 902 can be considered as indicating how semantically or substantively similar the natural language query 108 is to a respective one of the plurality of sentence fragments 502. As a non-limiting example, the fragment similarity score 902(1) can be a scalar whose magnitude indicates how much the natural language query 108 resembles the sentence fragment 502(1). As another non-limiting example, the fragment similarity score 902(n) can be a scalar whose magnitude indicates how much the natural language query 108 resembles the sentence fragment 502(n). In various aspects, whichever one of the plurality of sentence fragments 502 has a fragment similarity score that is highest, maximum, or otherwise above any suitable threshold can be considered as being the portion of the sentence 106 that most resembles the natural language query 108.

In various embodiments, the execution component 116 can electronically transmit any of the sentence embedding 302, the query embedding 304, the plurality of fragment embeddings 602, the plurality of compressed fragment embeddings 702, the compressed query embedding 904, the similarity score 802, or the plurality of fragment similarity scores 902 to any suitable computing device (e.g., for downstream or follow-up processing). In various aspects, the execution component 116 can electronically render any of the sentence embedding 302, the query embedding 304, the plurality of fragment embeddings 602, the plurality of compressed fragment embeddings 702, the compressed query embedding 904, the similarity score 802, or the plurality of fragment similarity scores 902 on any suitable computer screen or electronic display (e.g., to notify a user or operator).

In various embodiments, the asymmetric relevance system 102 can generate (e.g., via the execution component 116) the sentence embedding 302 in response to receipt (e.g., by the access component 114) of an electronic instruction or command to execute the neural sentence encoder 104 on the sentence 106. Indeed, whatever user or computing client that issues such an instruction or command can be unaware of the herein-described benefits of asymmetric execution of the neural sentence encoder 104. Thus, such user or computing client might request normal or standard execution of the neural sentence encoder 104 on the sentence 106 (e.g., can request that the neural sentence encoder 104 be executed on the sentence 106 in its entirety, without first fragmenting the sentence 106). The execution component 116 can respond to such request for standard or normal execution not be executing the neural sentence encoder 104 in standard or normal fashion on the sentence 106, but instead by asymmetrically executing the neural sentence encoder 104 with respect to the sentence 106 as described herein (e.g., by fragmenting the sentence 106, independently executing the neural sentence encoder 104 on those fragments, and then fusing the resulting fragment embeddings).

Although various embodiments described herein mainly involve fusing the plurality of fragment embeddings 602 (or the plurality of compressed fragment embeddings 702) together via concatenation, these are mere non-limiting examples for ease of explanation and illustration. In other embodiments, such fusing can be accomplished in any other suitable fashion, such as via vector addition, unweighted vector averaging, or weighted vector averaging.

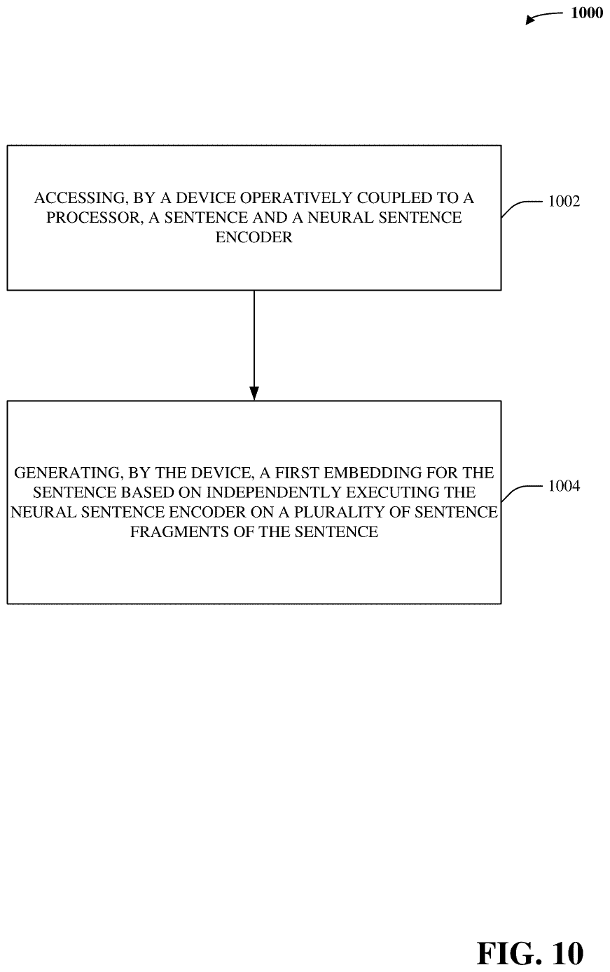

FIG. 10 illustrates a flow diagram of an example, non-limiting computer-implemented method 1000 that can facilitate asymmetric relevance via fragment-wise execution of neural sentence encoders in accordance with one or more embodiments described herein. In various cases, the asymmetric relevance system 102 can facilitate the computer-implemented method 1000.

In various embodiments, act 1002 can include accessing, by a device (e.g., via 114) operatively coupled to a processor (e.g., 110), a sentence (e.g., 106) and a neural sentence encoder (e.g., 104).

In various aspects, act 1004 can include generating, by the device (e.g., via 116), a first embedding (e.g., 302) for the sentence based on independently executing the neural sentence encoder on a plurality of sentence fragments (e.g., 502) of the sentence.

Although not explicitly shown in FIG. 10, independent execution of the neural sentence encoder on the plurality of sentence fragments can yield a plurality of fragment embeddings (e.g., 602), and the first embedding for the sentence can be based on fusing the plurality of fragment embeddings. In some cases, the fusing can include: projecting, by the device (e.g., via 116), each of the plurality of fragment embeddings into a reduced-dimensionality format, thereby yielding a plurality of compressed fragment embeddings (e.g., 702); and concatenating, by the device (e.g., via 116), the plurality of compressed fragment embeddings together. In other cases, the fusing can include: concatenating or adding, by the device (e.g., via 116), the plurality of fragment embeddings together.

Although not explicitly shown in FIG. 10, the computer-implemented method 1000 can include: accessing, by the device (e.g., via 114), a natural language query (e.g., 108); generating, by the device (e.g., via 116), a second embedding (e.g., 304) for the natural language query based on executing the neural sentence encoder on the natural language query and not based on independently executing the neural sentence encoder on a plurality of fragments of the natural language query; computing, by the device (e.g., via 116), a similarity score (e.g., 802) between the first embedding and the second embedding; and determining, by the device (e.g., via 116), that the sentence semantically answers the natural language query, in response to the similarity score exceeding a threshold.

Although not explicitly shown in FIG. 10, the computer-implemented method 1000 can include: computing, by the device (e.g., via 116) and in response to a determination that the sentence semantically answers the natural language query, a respective second similarity score between the second embedding and each of the plurality of fragment embeddings, thereby yielding a plurality of second similarity scores (e.g., 902); and localizing, by the device (e.g., via 116), a most semantically-relevant one of the plurality of sentence fragments, based on identifying which of the plurality of second similarity scores exceeds the threshold.

Although various embodiments described herein involve the neural sentence encoder 104 being executed on grammatical sentences or fragments thereof, these are mere non-limiting examples for ease of explanation and illustration. Various embodiments described herein can be readily extrapolated for use with any other suitable types of textual passages (e.g., not limited just to grammatical sentences). Indeed, a neural sentence encoder can receive as input any string, chain, or passage of text and can produce as output a fixed-dimensionality embedding that numerically represents the substantive or semantic content of that string, chain, or passage of text. Accordingly, in various embodiments, the sentence 106 can be broadened or generalized to any suitable textual passage made up of any suitable number of words. As some non-limiting examples, the sentence 106 can be replaced or substituted with: a paragraph of sentences; two or more paragraphs; an entire chapter of paragraphs; multiple chapters; or even entire webpages or books of text. In such case, the plurality of sentence fragments 502 can be broadened or generalized to a plurality of passage fragments (also referred to as a plurality of textual sub-passages), where each passage fragment can be any suitable contiguous or unbroken strict sub-sequence of words from the textual passage. Likewise, in various aspects, the natural language query 108 can be broadened or generalized to any suitable textual passage (e.g., any suitable number of paragraphs, chapters, webpages, or books). No matter what particular grammatical form that such textual passages take, the neural sentence encoder 104 can be executed in asymmetric fashion on such textual passages so as to more accurately or more reliably determine whether or not they are semantically relevant to each other (e.g., the neural sentence encoder 104 can be executed on an entirety of whichever textual passage replaces the natural language query 108; and the neural sentence encoder 104 can instead be executed on parsed fragments or sub-passages of whatever textual passage replaces the sentence 106).

Accordingly, various embodiments described herein can involve: accessing, by a device (e.g., 114) operatively coupled to a processor (e.g., 110), a first textual passage (e.g., 106) and a neural sentence encoder (e.g., 104); and generating, by the device (e.g., via 116), a first embedding (e.g., 302) for the first textual passage based on independently executing the neural sentence encoder on a plurality of fragments (e.g., 502) of the first textual passage. In various aspects, independent execution of the neural sentence encoder on the plurality of fragments can yield a plurality of fragment embeddings (e.g., 602), and the first embedding for the first textual passage can be based on fusing the plurality of fragment embeddings. In some instances, the fusing can include concatenating or adding the plurality of fragment embeddings together. In other instances, the fusing can include projecting each of the plurality of fragment embeddings into a reduced-dimensionality format, thereby yielding a plurality of compressed fragment embeddings (e.g., 702), and concatenating the plurality of compressed fragment embeddings together. In various cases, such embodiments can further involve: accessing, by the device (e.g., via 114), a second textual passage (e.g., 108); generating, by the device (e.g., via 116), a second embedding (e.g., 304) for the second textual passage based on executing the neural sentence encoder on the second textual passage and not based on independently executing the neural sentence encoder on a plurality of fragments of the second textual passage; computing, by the device (e.g., via 116), a similarity score (e.g., 802) between the first embedding and the second embedding; and determining, by the device (e.g., 116), that the first textual passage semantically relates to the second textual passage, in response to the similarity score exceeding a threshold. In various aspects, such embodiments can further include: computing, by the device (e.g., via 116) and in response to a determination that the first textual passage semantically relates to the second textual passage, a respective second similarity score between the second embedding and each of the plurality of fragment embeddings, thereby yielding a plurality of second similarity scores (e.g., 902); and localizing, by the device (e.g., via 116), a most semantically-relevant one of the plurality of fragments, based on identifying which of the plurality of second similarity scores exceeds the threshold. In various instances, the neural sentence encoder can be executed independently on the plurality of fragments, in response to receipt of an electronic instruction requesting execution of the neural sentence encoder on the first textual passage.

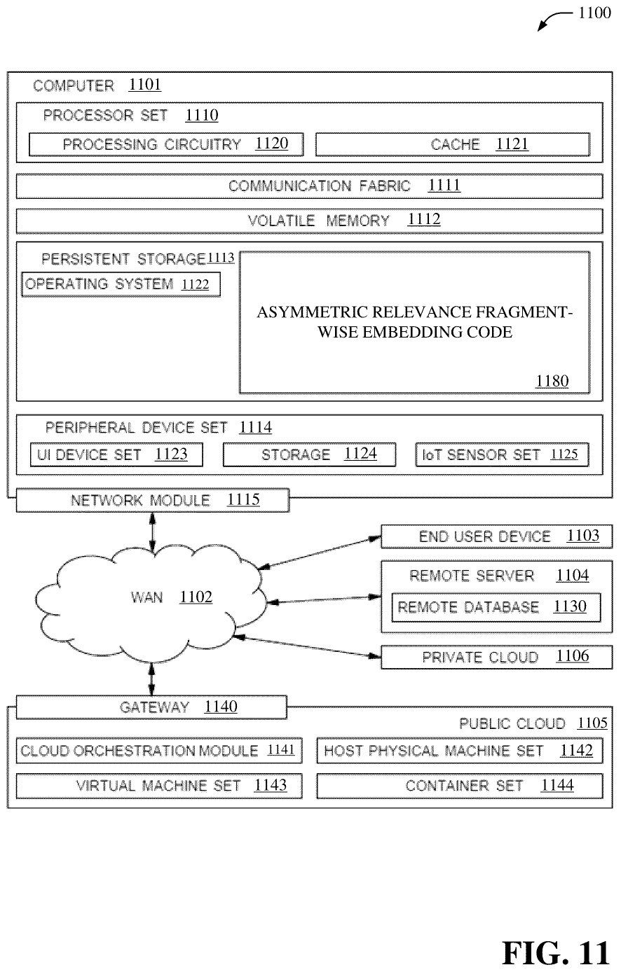

FIG. 11 and the following discussion are intended to provide a brief, general description of a suitable computing environment 1100 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as asymmetric relevance fragment-wise embedding code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1180, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method can be distributed among multiple computers or between multiple locations. On the other hand, in this presentation of computing environment 1100, detailed discussion is focused on a single computer, specifically computer 1101, to keep the presentation as simple as possible. Computer 1101 can be located in a cloud, even though it is not shown in a cloud in FIG. 11. On the other hand, computer 1101 is not required to be in a cloud except to any extent as can be affirmatively indicated.

PROCESSOR SET 1110 includes one, or more, computer processors of any type now known or to be developed in the future. Processing circuitry 1120 can be distributed over multiple packages, for example, multiple, coordinated integrated circuit chips. Processing circuitry 1120 can implement multiple processor threads or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set can be located “off chip.” In some computing environments, processor set 1110 can be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods can be stored in block 1180 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory can be distributed over multiple packages or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 or directly to persistent storage 1113. Persistent storage 1113 can be a read only memory (ROM), but typically at least a portion of the persistent storage allows writing of data, deletion of data and re-writing of data. Some familiar forms of persistent storage include magnetic disks and solid-state storage devices. Operating system 1122 can take several forms, such as various known proprietary operating systems or open-source Portable Operating System Interface type operating systems that employ a kernel. The code included in block 1180 typically includes at least some of the computer code involved in performing the inventive methods.

PERIPHERAL DEVICE SET 1114 includes the set of peripheral devices of computer 1101. Data communication connections between the peripheral devices and the other components of computer 1101 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 can include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 can be persistent or volatile. In some embodiments, storage 1124 can take the form of a quantum computing storage device for storing data in the form of qubits. In embodiments where computer 1101 is required to have a large amount of storage (for example, where computer 1101 locally stores and manages a large database) then this storage can be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor can be a thermometer and another sensor can be a motion detector.

NETWORK MODULE 1115 is the collection of computer software, hardware, and firmware that allows computer 1101 to communicate with other computers through WAN 1102. Network module 1115 can include hardware, such as modems or Wi-Fi signal transceivers, software for packetizing or de-packetizing data for communication network transmission, or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN can be replaced or supplemented by local area networks (LANs) designed to communicate data between devices located in a local area, such as a Wi-Fi network. The WAN or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and can take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 can be a client device, such as thin client, heavy client, mainframe computer or desktop computer.

REMOTE SERVER 1104 is any computer system that serves at least some data or functionality to computer 1101. Remote server 1104 can be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data can be provided to computer 1101 from remote database 1130 of remote server 1104.

PUBLIC CLOUD 1105 is any computer system available for use by multiple entities that provides on-demand availability of computer system resources or other computer capabilities, especially data storage (cloud storage) and computing power, without direct active management by the scale. The direct and active management of the computing resources of public cloud 1105 is performed by the computer hardware or software of cloud orchestration module 1141. The computing resources provided by public cloud 1105 are typically implemented by virtual computing environments that run on various computers making up the computers of host physical machine set 1142, which is the universe of physical computers in or available to public cloud 1105. The virtual computing environments (VCEs) typically take the form of virtual machines from virtual machine set 1143 or containers from container set 1144. It is understood that these VCEs can be stored as images and can be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware and firmware allowing public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 1105 and private cloud 1106 are both part of a larger hybrid cloud.

The embodiments described herein can be directed to one or more of a system, a method, an apparatus or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++ or the like, or procedural programming languages, such as the “C” programming language or similar programming languages. The computer readable program instructions can execute entirely on a computer, partly on a computer, as a stand-alone software package, partly on a computer or partly on a remote computer or entirely on the remote computer or server. In the latter scenario, the remote computer can be connected to a computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

While the subject matter has been described above in the general context of computer-executable instructions of a computer program product that runs on a computer or computers, those skilled in the art will recognize that the one or more embodiments herein also can be implemented at least partially in parallel with one or more other program modules. Generally, program modules include routines, programs, components or data structures that perform particular tasks or implement particular abstract data types. Moreover, the aforedescribed computer-implemented methods can be practiced with other computer system configurations, including single-processor or multiprocessor computer systems, mini-computing devices, mainframe computers, as well as computers, hand-held computing devices (e.g., PDA, phone), or microprocessor-based or programmable consumer or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples of various embodiments. For ease of description or explanation, various portions of the herein disclosure utilize the term “each”, “every”, or “all” when discussing various embodiments. Such usages of the term “each”, “every”, or “all” are non-limiting examples. In other words, when the herein disclosure provides a description that is applied to “each”, “every”, or “all” of some particular object or component, it should be understood that this is a non-limiting example of various embodiments, and it should be further understood that, in various other embodiments, it can be the case that such description applies to fewer than “each”, “every”, or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches or gates, in order to optimize space usage or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) or Rambus dynamic RAM (RDRAM). Also, the described memory components of systems or computer-implemented methods herein are intended to include, without being limited to including, these or any other suitable types of memory.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system, comprising:
a processor that executes computer-executable components stored in a non-transitory computer-readable memory, wherein the computer-executable components comprise:
an access component that accesses a first textual passage and a neural sentence encoder; and
an execution component that generates a first embedding for the first textual passage based on independently executing the neural sentence encoder on a plurality of fragments of the first textual passage.

2. The system of claim 1, wherein independent execution of the neural sentence encoder on the plurality of fragments yields a plurality of fragment embeddings, and wherein the first embedding for the first textual passage is based on fusing the plurality of fragment embeddings.

3. The system of claim 2, wherein the fusing comprises concatenating or adding the plurality of fragment embeddings together.

4. The system of claim 2, wherein the fusing comprises projecting each of the plurality of fragment embeddings into a reduced-dimensionality format, thereby yielding a plurality of compressed fragment embeddings, and concatenating the plurality of compressed fragment embeddings together.

5. The system of claim 2, wherein the access component accesses a second textual passage, and wherein the execution component:
generates a second embedding for the second textual passage based on executing the neural sentence encoder on the second textual passage and not based on independently executing the neural sentence encoder on a plurality of fragments of the second textual passage;
computes a similarity score between the first embedding and the second embedding; and
determines that the first textual passage semantically relates to the second textual passage, in response to the similarity score exceeding a threshold.

6. The system of claim 5, wherein the similarity score is based on a cosine similarity or Euclidean distance between the first embedding and the second embedding.

7. The system of claim 5, wherein, in response to a determination that the first textual passage semantically relates to the second textual passage, the execution component:
computes a respective second similarity score between the second embedding and each of the plurality of fragment embeddings, thereby yielding a plurality of second similarity scores; and
localizes a most semantically-relevant one of the plurality of fragments, based on identifying which of the plurality of second similarity scores exceeds the threshold.

8. The system of claim 1, wherein the execution component executes the neural sentence encoder independently on the plurality of fragments, in response to receipt of an electronic instruction requesting execution of the neural sentence encoder on the first textual passage.

9. The system of claim 1, wherein the execution component decomposes the first textual passage into the plurality of fragments via text parsing.

10. A computer-implemented method, comprising:
accessing, by a device operatively coupled to a processor, a first textual passage and a neural sentence encoder; and
generating, by the device, a first embedding for the first textual passage based on independently executing the neural sentence encoder on a plurality of fragments of the first textual passage.

11. The computer-implemented method of claim 10, wherein independent execution of the neural sentence encoder on the plurality of fragments yields a plurality of fragment embeddings, and wherein the first embedding for the first textual passage is based on fusing the plurality of fragment embeddings.

12. The computer-implemented method of claim 11, wherein the fusing comprises:
concatenating or adding, by the device, the plurality of fragment embeddings together.

13. The computer-implemented method of claim 11, wherein the fusing comprises:
projecting, by the device, each of the plurality of fragment embeddings into a reduced-dimensionality format, thereby yielding a plurality of compressed fragment embeddings; and
concatenating, by the device, the plurality of compressed fragment embeddings together.

14. The computer-implemented method of claim 11, further comprising:
accessing, by the device, a second textual passage;
generating, by the device, a second embedding for the second textual passage based on executing the neural sentence encoder on the second textual passage and not based on independently executing the neural sentence encoder on a plurality of fragments of the second textual passage;
computing, by the device, a similarity score between the first embedding and the second embedding; and
determining, by the device, that the first textual passage semantically relates to the second textual passage, in response to the similarity score exceeding a threshold.

15. The computer-implemented method of claim 14, wherein the similarity score is based on a cosine similarity or Euclidean distance between the first embedding and the second embedding.

16. The computer-implemented method of claim 14, further comprising:
computing, by the device and in response to a determination that the first textual passage semantically relates to the second textual passage, a respective second similarity score between the second embedding and each of the plurality of fragment embeddings, thereby yielding a plurality of second similarity scores; and
localizing, by the device, a most semantically-relevant one of the plurality of fragments, based on identifying which of the plurality of second similarity scores exceeds the threshold.

17. The computer-implemented method of claim 10, wherein the device executes the neural sentence encoder independently on the plurality of fragments, in response to receipt of an electronic instruction requesting execution of the neural sentence encoder on the first textual passage.

18. The computer-implemented method of claim 10, further comprising:
decomposing, by the device, the first textual passage into the plurality of fragments via text parsing.

19. A computer program product for facilitating asymmetric relevance via fragment-wise execution of neural sentence encoders, the computer program product comprising a non-transitory computer-readable memory having program instructions embodied therewith, the program instructions executable by a processor to cause the processor to:
access a first textual passage and a neural sentence encoder; and
generate a first embedding for the first textual passage based on independently executing the neural sentence encoder on a plurality of fragments of the first textual passage.

20. The computer program product of claim 19, wherein independent execution of the neural sentence encoder on the plurality of fragments yields a plurality of fragment embeddings, and wherein the first embedding for the first textual passage is based on fusing the plurality of fragment embeddings.
